(19) United States
(12) Patent Application Publication
(10) Pub. No.: US 2024/0281876 A1
(43) Pub. Date: Aug. 22, 2024

(54) System, Method, and Computer Program Product for Scoring Using Separate Predictive Models

(71) Applicant: Visa International Service Association, San Francisco, CA (US)

(72) Inventors: Zixin Qin, Singapore (SG); Lubna Akhtar, Singapore (SG); Ma Louisa Andrade, Singapore (SG); Abhijit Bandyopadhyay, Singapore (SG)

(21) Appl. No.: 18/112,737

(22) Filed: Feb. 22, 2023

(51) Int. Cl. G06Q 40/03

(52) U.S. Cl. CPC G06Q 40/03

(57) ABSTRACT

Provided is a system, method, and computer program product for scoring using separate predictive models. The system includes at least one processor programmed or configured to determine a subset of account holders from a plurality of account holders based on transaction data for each account holder of the plurality of account holders, determine a predicted future revenue score for each account holder of the subset of account holders based on a plurality of predictive models, and generate a segmentation matrix based on the predicted future revenue score and a risk score for each account holder of the subset of account holders.

### BACKGROUND

### 1. Technical Field

The present disclosure relates generally to predictive models and, in some non-limiting aspects or embodiments, to systems, methods, and computer program products for scoring using separate predictive models.

### 2. Technical Considerations

Issuers of accounts have no way of knowing the future profitability of the accounts without resorting to generalizations. For example, issuers have an interest identifying potential high value customers such that they are able to allocate resources differently across different customers (e.g., and corresponding accounts). Identifying the future profitability, however, is a complex and resource-intensive problem because of the various behavior patterns of account holders. Further, management and retention of the accounts and account holders is currently done manually for one or all accounts or account holders.

### SUMMARY

According to non-limiting embodiments or aspects, provided is a system comprising: at least one processor programmed or configured to: determine a subset of account holders from a plurality of account holders based on transaction data for each account holder of the plurality of account holders; determine a predicted future revenue score for each account holder of the subset of account holders based on a plurality of predictive models; and generate a segmentation matrix based on the predicted future revenue score and a risk score for each account holder of the subset of account holders. In non-limiting embodiments or aspects, the at least one processor is further programmed or configured to: automatically adjust a credit line value for at least one account holder of the subset of account holders based on the segmentation matrix.

In non-limiting embodiments or aspects, the at least one processor is further programmed or configured to: automatically generate an offer for at least one account holder of the subset of account holders based on the segmentation matrix. In non-limiting embodiments or aspects, wherein determining the subset of account holders comprises excluding account holders that are not associated with a threshold amount of transaction data. In non-limiting embodiments or aspects, wherein determining the subset of account holders comprises excluding account holders that were issued an account within a predetermined time period. In non-limiting embodiments or aspects, the plurality of predictive models comprises a predictive interchange revenue model configured to output a component of the predicted future revenue score based at least partially on at least one interchange fee value and a predicted spend amount. In non-limiting embodiments or aspects, the plurality of predictive models comprises a first predictive interest model applied to a first group of account holders and a second predictive interest model applied to a second group of account holders to output a component of the predicted future revenue score. In non-limiting embodiments or aspects, the plurality of predictive models comprises a foreign transaction fee model configured to output a component of the predicted future revenue score based at least partially on a foreign transaction fee percentage and a predicted cross-border spend amount.

According to non-limiting embodiments or aspects, provided is a computer-implemented method comprising: determining, with at least one processor, a subset of account holders from a plurality of account holders based on transaction data for each account holder of the plurality of account holders; determining, with at least one processor, a predicted future revenue score for each account holder of the subset of account holders based on a plurality of predictive models; and generating, with at least one processor, a segmentation matrix based on the predicted future revenue score and a risk score for each account holder of the subset of account holders.

In non-limiting embodiments or aspects, wherein determining the subset of account holders comprises excluding account holders that are not associated with a threshold amount of transaction data. In non-limiting embodiments or aspects, wherein determining the subset of account holders comprises excluding account holders that were issued an account within a predetermined time period. In non-limiting embodiments or aspects, wherein at least one model of the plurality of predictive models is configured to output the predicted future revenue score based at least partially on at least one interchange fee value. In non-limiting embodiments or aspects, the method further comprises: automatically adjusting a credit line value for at least one account holder of the subset of account holders based on the segmentation matrix. In non-limiting embodiments or aspects, the method further comprises: automatically generating an offer for at least one account holder of the subset of account holders based on the segmentation matrix. In non-limiting embodiments or aspects, the plurality of predictive models comprises a predictive interchange revenue model configured to output a component of the predicted future revenue score based at least partially on at least one interchange fee value and a predicted spend amount. In non-limiting embodiments or aspects, the plurality of predictive models comprises a first predictive interest model applied to a first group of account holders and a second predictive interest model applied to a second group of account holders to output a component of the predicted future revenue score. In non-limiting embodiments or aspects, the plurality of predictive models comprises a foreign transaction fee model configured to output a component of the predicted future revenue score based at least partially on a foreign transaction fee percentage and a predicted cross-border spend amount.

According to non-limiting embodiments or aspects, provided is a computer program product comprising at least one non-transitory computer-readable medium including program instructions that, when executed by at least one processor, cause the at least one processor to: determine a subset of account holders from a plurality of account holders based on transaction data for each account holder of the plurality of account holders; determine a predicted future revenue score for each account holder of the subset of account holders based on at least one model; and generate a segmentation matrix based on the predicted future revenue score and a risk score for each account holder of the subset of account holders. In non-limiting embodiments or aspects, the program instructions further cause the at least one processor to: automatically adjust a credit line value for at least one account holder of the subset of account holders based on the segmentation matrix. In non-limiting embodiments or aspects, the program instructions further cause the at least one processor to: automatically generate an offer for at least one account holder of the subset of account holders based on the segmentation matrix.

Further embodiments or aspects are set forth in the following numbered clauses:

Clause 1: A system comprising: at least one processor programmed or configured to: determine a subset of account holders from a plurality of account holders based on transaction data for each account holder of the plurality of account holders; determine a predicted future revenue score for each account holder of the subset of account holders based on a plurality of predictive models; and generate a segmentation matrix based on the predicted future revenue score and a risk score for each account holder of the subset of account holders.

Clause 2: The system of clause 1, wherein the at least one processor is further programmed or configured to: automatically adjust a credit line value for at least one account holder of the subset of account holders based on the segmentation matrix.

Clause 3: The system of clauses 1 or 2, wherein the at least one processor is further programmed or configured to: automatically generate an offer for at least one account holder of the subset of account holders based on the segmentation matrix.

Clause 4: The system of any of clauses 1-3, wherein determining the subset of account holders comprises excluding account holders that are not associated with a threshold amount of transaction data.

Clause 5: The system of any of clauses 1-4, wherein determining the subset of account holders comprises excluding account holders that were issued an account within a predetermined time period.

Clause 6: The system of any of clauses 1-5, wherein the plurality of predictive models comprises a predictive interchange revenue model configured to output a component of the predicted future revenue score based at least partially on at least one interchange fee value and a predicted spend amount.

Clause 7: The system of any of clauses 1-6, wherein the plurality of predictive models comprises a first predictive interest model applied to a first group of account holders and a second predictive interest model applied to a second group of account holders to output a component of the predicted future revenue score.

Clause 8: The system of any of clauses 1-7, wherein the plurality of predictive models comprises a foreign transaction fee model configured to output a component of the predicted future revenue score based at least partially on a foreign transaction fee percentage and a predicted cross-border spend amount.

Clause 9: A computer-implemented method comprising: determining, with at least one processor, a subset of account holders from a plurality of account holders based on transaction data for each account holder of the plurality of account holders; determining, with at least one processor, a predicted future revenue score for each account holder of the subset of account holders based on a plurality of predictive models; and generating, with at least one processor, a segmentation matrix based on the predicted future revenue score and a risk score for each account holder of the subset of account holders.

Clause 10: The computer-implemented method of clause 9, wherein determining the subset of account holders comprises excluding account holders that are not associated with a threshold amount of transaction data.

Clause 11: The computer-implemented method of clauses 9 or 10, wherein determining the subset of account holders comprises excluding account holders that were issued an account within a predetermined time period.

Clause 12: The computer-implemented method of any of clauses 9-11, wherein at least one model of the plurality of predictive models is configured to output the predicted future revenue score based at least partially on at least one interchange fee value.

Clause 13: The computer-implemented method of any of clauses 9-12, further comprising: automatically adjusting a credit line value for at least one account holder of the subset of account holders based on the segmentation matrix.

Clause 14: The computer-implemented method of any of clauses 9-13, further comprising: automatically generating an offer for at least one account holder of the subset of account holders based on the segmentation matrix.

Clause 15: The computer-implemented method of any of clauses 9-14, wherein the plurality of predictive models comprises a predictive interchange revenue model configured to output a component of the predicted future revenue score based at least partially on at least one interchange fee value and a predicted spend amount.

Clause 16: The computer-implemented method of any of clauses 9-15, wherein the plurality of predictive models comprises a first predictive interest model applied to a first group of account holders and a second predictive interest model applied to a second group of account holders to output a component of the predicted future revenue score.

Clause 17: The computer-implemented method of any of clauses 9-16, wherein the plurality of predictive models comprises a foreign transaction fee model configured to output a component of the predicted future revenue score based at least partially on a foreign transaction fee percentage and a predicted cross-border spend amount.

Clause 18: A computer program product comprising at least one non-transitory computer-readable medium including program instructions that, when executed by at least one processor, cause the at least one processor to: determine a subset of account holders from a plurality of account holders based on transaction data for each account holder of the plurality of account holders; determine a predicted future revenue score for each account holder of the subset of account holders based on at least one model; and generate a segmentation matrix based on the predicted future revenue score and a risk score for each account holder of the subset of account holders.

Clause 19: The computer program product of clause 18, wherein the program instructions further cause the at least one processor to: automatically adjust a credit line value for at least one account holder of the subset of account holders based on the segmentation matrix.

Clause 20: The computer program product of clauses 18 or 19, wherein the program instructions further cause the at least one processor to: automatically generate an offer for at least one account holder of the subset of account holders based on the segmentation matrix.

These and other features and characteristics of the presently disclosed subject matter, as well as the methods of operation and functions of the related elements of structures and the combination of parts and economies of manufacture, will become more apparent based on the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments or aspects that are illustrated in the accompanying figures, in which:

FIG. 1 is a schematic diagram of a system for scoring using separate predictive models according to non-limiting aspects or embodiments;

FIG. 2 illustrates a model architecture for scoring using separate predictive models according to non-limiting aspects or embodiments;

FIG. 3 is a flowchart of a method for scoring using separate predictive models according to non-limiting aspects or embodiments;

FIG. 4 shows model performance metrics of an interest prediction model for a first type of account holder (e.g., “revolver” account holders) according to non-limiting embodiments or aspects;

FIG. 5 shows model performance metrics of an interest prediction model for a second type of account holder (e.g., “transactor” account holders) according to non-limiting embodiments or aspects;

FIG. 6 shows model performance metrics of an interchange fee prediction using a total spend prediction model according to non-limiting embodiments or aspects;

FIG. 7 shows model performance metrics of a cross-border fee prediction using a cross-border spend prediction model according to non-limiting embodiments or aspects;

FIG. 8 shows a revenue scorecard according to non-limiting embodiments or aspects;

FIG. 9 shows a segmentation matrix according to non-limiting embodiments or aspects; and

FIG. 10 is a diagram of components of one or more devices of FIG. 1 according to non-limiting aspects or embodiments.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments, a message may refer to a network packet (e.g., a data packet and/or the like) that includes data.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “issuer,” “issuer institution,” “issuer bank,” or “payment device issuer” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments, an issuer may be associated with a bank identification number (BIN) that uniquely identifies the issuer institution. As used herein, “issuer system” may refer to one or more computer systems operated by or on behalf of an issuer, such as a server executing one or more software applications. For example, an issuer system may include one or more authorization servers for authorizing a transaction.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, “merchant system” may refer to one or more computer systems operated by or on behalf of a merchant, such as a server executing one or more software applications. As used herein, the term “product” may refer to one or more goods and/or services offered by a merchant.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa, MasterCard®, American Express®, or any other entity that processes transactions. As used herein, “transaction processing system” may refer to one or more computer systems operated by or on behalf of a transaction service provider, such as a transaction processing server executing one or more software applications. A transaction processing system may include one or more processors and, in some non-limiting embodiments, may be operated by or on behalf of a transaction service provider.

Non-limiting embodiments are directed to systems, methods, and computer program products for scoring using separate predictive models that provide for advantages over existing methods for revenue prediction. For example, by using multiple, separate predictive models for components of an overall revenue score, non-limiting embodiments allow for an efficient use of computing resources by avoiding unnecessary processing. In some examples, the output of a model may be used as an input for multiple different determinations, avoiding redundant processing and economizing the use of computing resources.

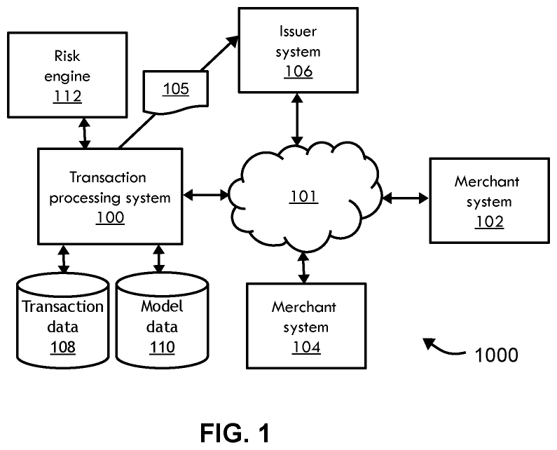

Referring now to FIG. 1, a system 1000 for scoring using separate predictive models is shown according to non-limiting aspects or embodiments. A transaction processing system 100 associated with a transaction service provider is in communication with transaction data 108 stored in one or more data storage devices that may be local and/or remote to the transaction processing system 100. The transaction data 108 may include historical transactions processed by the transaction processing system 100, such as transactions between account holders and various merchants (e.g., associated with merchant systems 102, 104). The account holders may have accounts issued by one or multiple different issuers (e.g., an issuer system 106 and/or other issuer systems). The devices and systems shown in FIG. 1 may communicate through a network environment 101, such as the Internet and/or one or more private networks. In some non-limiting embodiments, at least some of the devices and systems shown in FIG. 1 may communicate through an electronic payment processing network.

With continued reference to FIG. 1, the transaction processing system 100 is in communication with model data 110 stored in one or more data storage devices that may be local and/or remote to the transaction processing system 100. The model data 110 may include a plurality of different predictive models. The models may be configured to output a predicted revenue score. A predicted revenue score may include, for example, a revenue value and/or other metric representing future revenue for one or more account holders based on transaction data 108 associated with the one or more account holders. Each predictive model may be configured to output a component of a total revenue, such as interest revenue, interchange fee revenue, and/or foreign transaction fee revenue. In some examples, one or more predictive models may be configured to output a value that is used to determine a component of a total revenue, such as a total predicted spend amount, a predicted cross-border spend amount, and/or the like. The models may predict revenue for a single account or account holder and/or a group of accounts or account holders.

With continued reference to FIG. 1, the transaction processing system 100 may generate a predicted revenue scorecard for one or more accounts that represents an aggregation of the components of the total revenue. The predicted revenue scorecard may be generated based on the output from each of the separate models. In some examples, the predicted revenue scorecard may provide metrics for each account or segment of accounts from a set of eligible accounts determined from a larger set of accounts.

With continued reference to FIG. 1, the transaction processing system 100 may also be in communication with a risk engine 112. The risk engine 112 may include one or more computing devices and/or software applications executing on one or more computing devices. In some examples, the risk engine 112 may be local to, part of, or remote from the transaction processing system 100. In some examples, the risk engine 112 may be local to, part of, or remote from the issuer system 106. In operation, the transaction processing system 100 may request a risk score from the risk engine 112 before and/or while (e.g., concurrent with) processing a transaction and/or executing one or more predictive models. For example, a risk score from a prior transaction may be stored as transaction data 108 such that it can be retrieved by querying a database.

In non-limiting embodiments, the transaction processing system 100 or another system may generate a segmentation matrix 105 based on the predicted revenue and the risk score. The segmentation matrix 105 may be output and communicated to the issuer system 106 corresponding to the account holder or group of account holders. The segmentation matrix 105 may also be stored locally to the transaction processing system 100. In some non-limiting embodiments, the predicted revenue and/or risk score may be separately communicated to the issuer system 106. In some non-limiting embodiments, a different entity, such as a payment gateway, authentication service, and/or the like, may receive the segmentation matrix 105 and/or predicted revenue scorecard. In some non-limiting embodiments, the segmentation matrix 105 is generated by overlaying a subset of identified account holders with the revenue scorecards and further combining this data with a risk score. The segmentation matrix may be used by entities, such as issuers, to determine portfolio management strategies. In some non-limiting embodiments, the segmentation matrix may be used to automatically implement one or more programs (e.g., such as campaigns, offers, and/or the like) based on issuer-specified parameters.

Non-limiting embodiments allow for account holder-level (e.g., customer-level) revenue to be predicted for a future time period. The time period for which the revenue is predicted may be a next day, week, month, quarter, year, multiple years, and/or any other future time period. The predictive models may be trained on transaction data, such as customer activity, delinquency status, block status, vintage (e.g., age of the account), statement balance, retail spend, payment timing, interest, cash advance overdraws, credit card or debit card transaction amounts, transaction dates, transaction types (e.g., cross-border, domestic, etc.), purchase channel, payment method, merchant category code (MCC) for purchases, card status, credit limits, month on book, and/or the like. In some non-limiting embodiments, account holder data may also be used to train the models and/or as input to the models, including account holder age, gender, education, job type, residence/address type, and/or the like.

In some non-limiting embodiments, a plurality of different account holders may be analyzed by processing transaction data associated with account holders with a plurality of predictive models, combining the model outputs, and then identifying those account holders that have a predicted revenue that satisfies a threshold (e.g., meets or exceeds a threshold value). For example, a subset of account holders having predictive revenues that satisfy a threshold may be identified for one or more offers (e.g., promotions, products, types of accounts, credit lines, and/or the like).

In non-limiting embodiments, one or more of the predictive models may be trained based on transaction data and/or customer data. For example, transactions from an observation window of time (e.g., the past year, two years, or any other time period) may be used to train the different models. Different cohorts of training data may be used for different time windows. For example, for a base observation point of September 2022, a first training cohort may include data from September 2021 to August 2022. For a base observation point of December 2022, a second training cohort may include data from December 2021 to November 2022. Cohorts can be of any length of time and of any interval. For example, base observation points may be every month, every two months, every three months or every quarter, and/or the like. The revenue prediction may be for a future time period such as the next day, week, month, quarter, year, multiple years, and/or the like. In some non-limiting embodiments, the time period for the revenue prediction may be the same as the time period for the training. For example, for a base observation point of December 2022 and a training cohort from December 2021 to November 2022, revenue may be predicted for January 2023 to December 2023. Likewise, for a base observation point of March 2023 and a training cohort from March 2022 to February 2023, revenue may be predicted for April 2023 to March 2024.

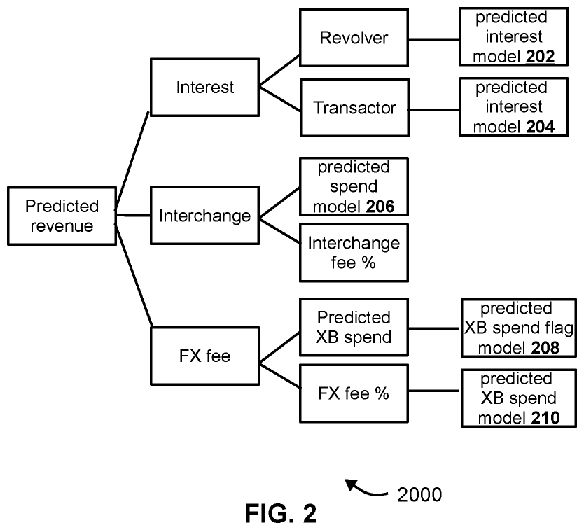

Referring now to FIG. 2, a model architecture 2000 is shown according to non-limiting embodiments. It will be appreciated that the models shown in 2000 may be separate models and/or may be incorporated as submodels to one or more larger models. Various arrangements are possible. The predicted revenue may have subcomponents such as interest revenue, interchange revenue, and foreign transaction (FX) fee revenue. The interest revenue may be determined based on two predictive models, including a first predictive interest model 202 for transactions from a first type of account holder (e.g., such as a “revolver” who regularly maintains a balance that incurs fees from the balance) and a second predicted interest model 204 for transactions from a second type of account holder (e.g., such as a “transactor” who regularly pays off any balances at the end of a billing cycle).

The interchange revenue may be determined based on a predictive spend model 206 and an interchange fee percentage. The foreign transaction revenue may be determined based on predicted cross-border (XB) spending, as determined from a predicted cross-border transaction spend flag model 208 (e.g., a model to predict whether an account holder will make a cross-border transaction), and a foreign transaction fee percentage, as determined from a predicted cross-border transaction spend model 210 (e.g., a model to predict the cross-border spend amount for those predicted to make a cross-border transaction). For example, the predicted cross-border transaction spend flag model 208 may be executed at a first stage of a foreign transaction revenue determination. The predicted cross-border spend may be determined to be zero in response to determining that an account holder is not predicted to engage in any cross-border transactions. For those account holders that are predicted to engage in one or more cross-border transactions, a second stage of the foreign transaction revenue determination may include executing the predicted cross-border transaction spend model 210. The predicted cross-border spend amount, from model 210, may be used to determine the foreign transaction revenue by, for example, multiplying it by the foreign transaction fee percentage. It will be appreciated that additional and/or different revenue components may be included in the model architecture and that any number of different predictive models may be used.

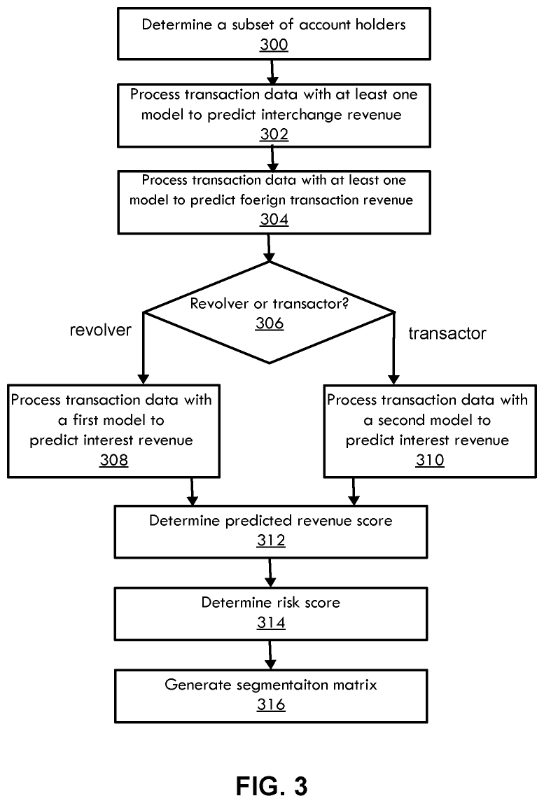

Referring to FIG. 3, shown is a flow diagram for a method of scoring using separate predictive models according to non-limiting embodiments or aspects. The steps shown in FIG. 3 are for example purposes only. It will be appreciated that non-limiting embodiments may involve additional steps, fewer steps, different steps, and/or a different order of steps. For example, several of the steps shown in FIG. 3 may be performed in parallel, rather than in a sequence as shown. In some non-limiting embodiments or aspects, a step may be performed automatically in response to the completion of a previous step (e.g., may be performed without user intervention upon the completion of a previous step). At a first step 300, a subset of account holders is determined from a total number of account holders based on any number of parameters. For example, a set of eligible account holders may be identified based on customer activity, delinquency status, block status, vintage (e.g., age of the account), and/or the like. In some non-limiting embodiments, however, all account holders may be analyzed.

At step 302, transaction data and/or account holder data for each account holder (e.g., for each account) may be processed with one or more predictive models to determine a predicted interchange revenue for the account and/or account holder. As an example, the predicted interchange revenue may be based on a predicted spend model and an interchange fee percentage (e.g., by determining the predicted spend for the account holder and then calculating the percent of that spend as the interchange fee). At step 304, transaction data and/or account holder data for each account holder (e.g., for each account) may be processed with one or more predictive models to determine a predicted foreign transaction revenue for the account and/or account holder. Although FIG. 3 shows step 304 being performed after step 302, it will be appreciated that these steps may be performed in parallel and/or in a different order.

At step 306, it is determined if the account holder is a first type of account holder (e.g., a “revolver”) or a second type of account holder (e.g., a “transactor”). Based on the type of account holder, one or more different predictive models may be used to process transaction data and/or account holder data to determine a predicted interest revenue. For example, if the account holder is determined to be a first type of account holder, the method may proceed to step 308 and a first predictive model may be applied. If the account holder is determined to be a second type of account holder, the method may proceed to step 310 and a second predictive model may be applied. The first predictive model and second predictive model may be different models. Although FIG. 3 shows a determination between a first model and a second model for determining a predicted interest revenue, it will be appreciated that any number of models and/or types of account holders may be used in non-limiting embodiments. Further, although FIG. 3 shows steps 306, 308, 310 being performed after step 304, it will be appreciated that these steps may be performed in parallel and/or in a different order with steps 302, 304.

At step 312, a predicted revenue score is determined. The predicted revenue score may be a summation of the predicted interchange revenue from step 302, the predicted interchange foreign transaction revenue from step 304, and the predicted interest revenue from steps 306, 308, 310. In some non-limiting embodiments, the predicted revenue score may be a metric (e.g., a numerical score, a categorical score such as low, medium, or high, and/or the like) based on a predicted revenue in dollars and cents (or other currency units). In some non-limiting embodiments, a predicted revenue scorecard may be generated for one or more account holders and/or accounts to be conveyed to an entity, such as an issuer system. In some non-limiting embodiments, the method may end here before generating a risk score and/or segmentation matrix.

At step 314, a risk score may be determined for the account holder and/or account. Although FIG. 3 shows step 314 being performed after step 312, it will be appreciated that these steps may be performed in parallel and/or in a different order. For example, a risk engine may be queried at any part of the process shown in FIG. 3 to return a risk score based on transaction data and/or account holder data. The risk engine may be a separate system and/or service in some examples, although it may also be integrated into a transaction processing system or any other system in an electronic payment processing network.

At step 316, the predicted revenue score and the risk score may be combined to generate a segmentation matrix. The segmentation matrix may be communicated to one or more entities. For example, in non-limiting embodiments, the segmentation matrix may be automatically communicated to an issuer system corresponding to the account corresponding to the segmentation matrix. In some non-limiting embodiments, the segmentation matrix and/or predicted revenue score may be used to automatically perform one or more actions. For example, the segmentation matrix and/or predicted revenue score may be used to automatically communicate offers, adjust credit limits, conduct customer retention programs, and/or the like, based on one or more thresholds. In some examples, the set of analyzed accounts and/or account holders may be categorized into one or more categories such that subsets of the group can be identified for offers or other like actions.

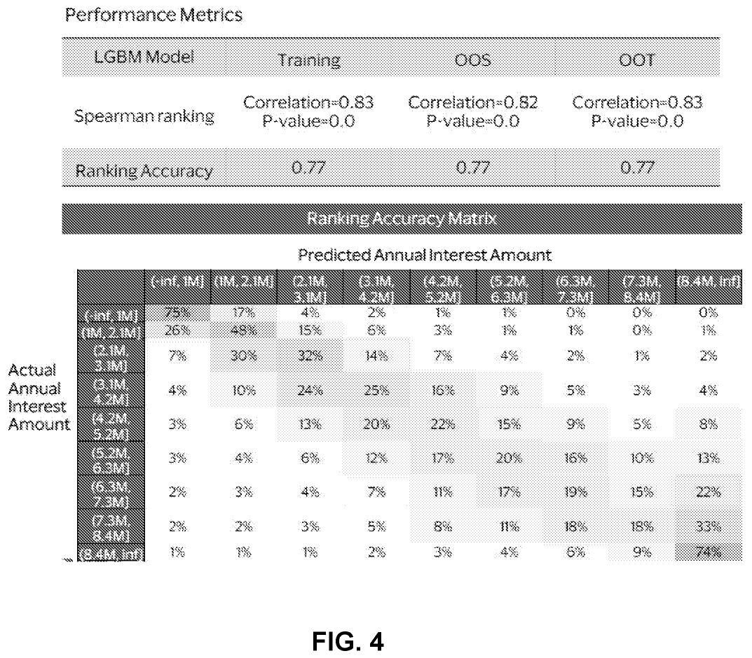

Referring to FIG. 4, shown are model performance metrics of an interest prediction model for a first type of account holder (e.g., “revolver” account holder) according to non-limiting embodiments or aspects.

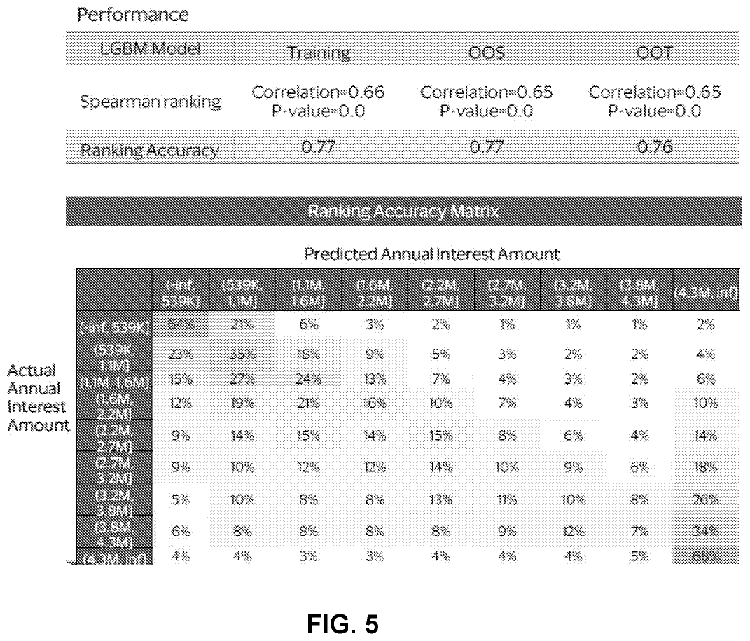

Referring to FIG. 5, shown are model performance metrics of an interest prediction model for a second type of account holder (e.g., “transactor” account holder) according to non-limiting embodiments or aspects.

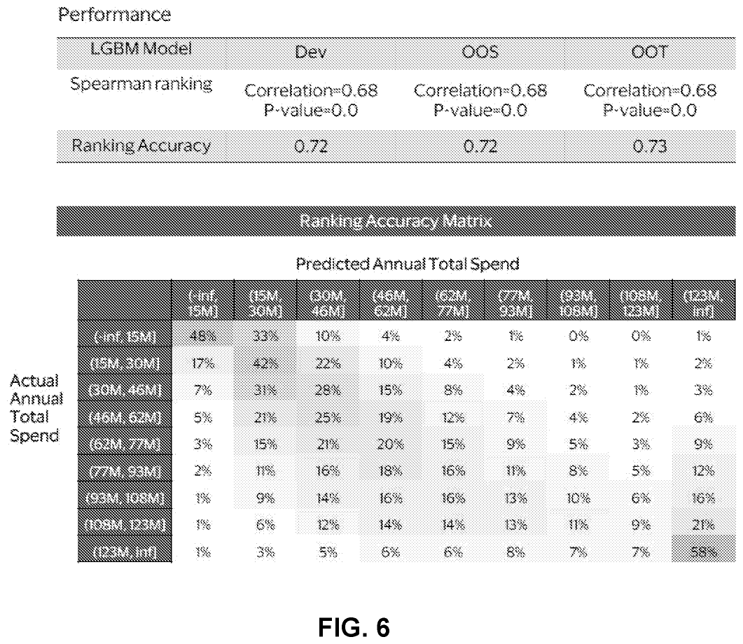

Referring to FIG. 6, shown are model performance metrics of an interchange fee prediction using a total spend prediction model according to non-limiting embodiments or aspects.

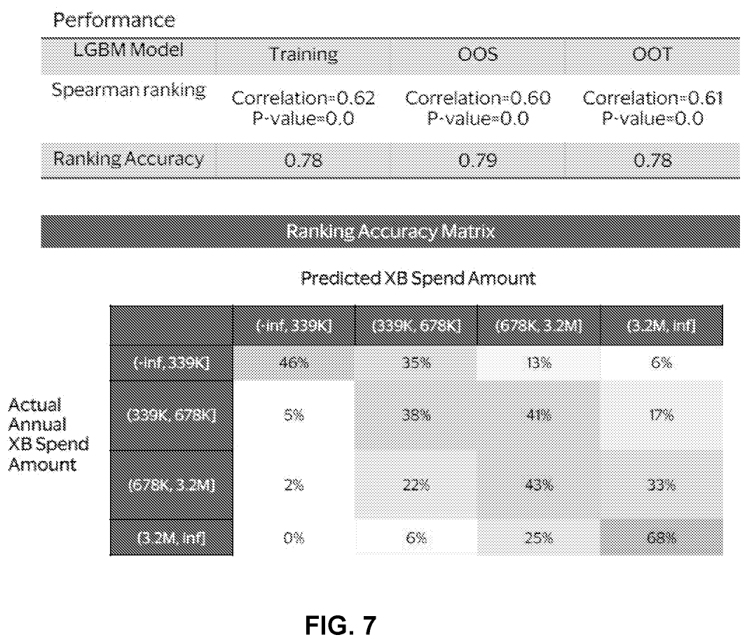

Referring to FIG. 7, shown are model performance metrics of a cross-border fee prediction using a cross-border spend prediction model according to non-limiting embodiments or aspects.

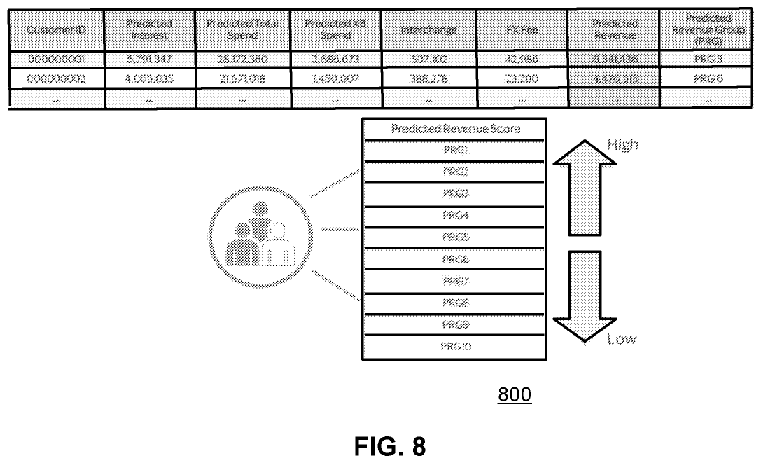

Referring to FIG. 8, a revenue scorecard 800 is shown according to non-limiting embodiments or aspects. The revenue scorecard 800 may be static and/or dynamic, such as a document, a webpage, an image, a spreadsheet, and/or the like. The revenue scorecard may visualize the different revenue components and/or model outputs. Further, the revenue scorecard 800 may categorize the accounts and/or account holders into one of a plurality of groups (e.g., PRG1, PRG2, PRG3, etc.) based on the revenue score. For example, each group may be defined by threshold revenue scores such that each individual revenue score is compared to the thresholds to determine the highest threshold it satisfies (e.g., meets or exceeds).

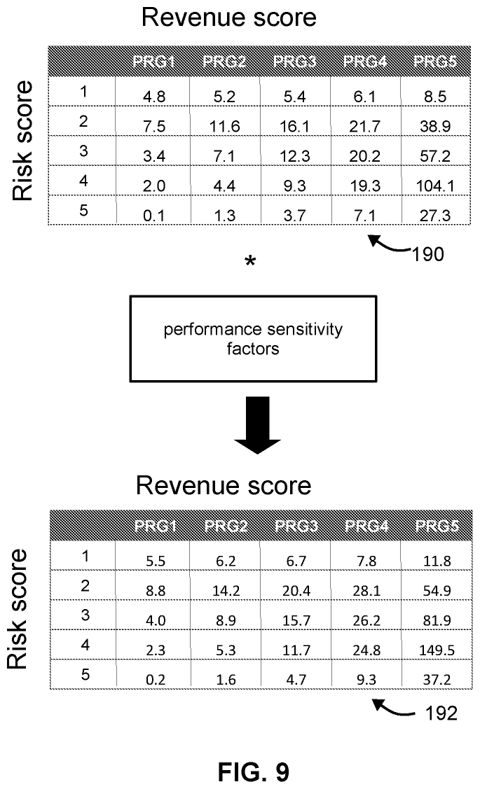

Referring now to FIG. 9, an example segmentation matrix 190, 192 is shown according to non-limiting embodiments. The segmentation matrix 190, 192 shows a relation between risk scores and revenue scores to enable users (e.g., such as issuers) to determine a revenue opportunity and/or as input to perform automated actions as a result of the data. The segmentation matrix 190, 192 may be aggregated for a segment (e.g., subset) of account holders and/or accounts. For example, a segmentation matrix 190 may be generated for each of the groups shown in the scorecard of FIG. 8 (e.g., PRG1, PRG2, PRG3, etc.). In non-limiting embodiments, an initial segmentation matrix 190 may be transformed into a transformed segmentation matrix 192 by applying performance sensitivity factors to the initial segmentation matrix 190. For example, the initial segmentation matrix 190 may represent a baseline scenario based on model predictions and aggregated at the segment level. The transformed segmentation matrix 192 may represent a simulated scenario based on a simulated credit limit increase (CLI) by applying sensitivity factors by customer segment. For example, each group (e.g., PRG1, PRG2, PRG3, PRG4, PRG5) may be associated with different performance sensitivity factors that are multiplied to the values in the initial segmentation matrix 190. The resulting transformed segmentation matrix 192 may represent a simulated revenues (e.g., predicted revenues) that may result from a specified CLI (e.g., a 10% CLI, a 15% CLI, a 20% CLI, and/or the like) that can be used as revenue opportunities by banks and/or other entities in a payment processing network. In non-limiting embodiments, the segmentation matrix 192 may be used to create a customized model to a particular segment. For example, a customized strategy model may be created for analysis and/or modeling-based activities. In some non-limiting embodiments, the segmentation matrix 192 may be used as an input to one or more automated processes that automatically identify offers (e.g., discounts, coupons, purchase incentives, and/or the like) and/or automatically generate custom offers for one or more segments. In some examples, a CLI may be automatically processed for one or more segments in which predicted revenue satisfies a threshold. Although FIG. 9 shows a matrix being transformed to simulate CLI, it will be appreciated that various other changes to account status may be simulated in non-limiting embodiments.

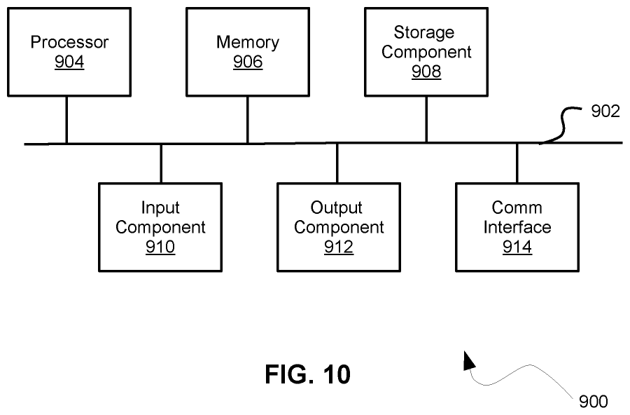

Referring now to FIG. 10, shown is a diagram of example components of a computing device 900 for implementing and performing the systems and methods described herein according to non-limiting embodiments. In some non-limiting embodiments, device 900 may include additional components, fewer components, different components, or differently arranged components than those shown in FIG. 10. Device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), virtual or augmented reality depicting systems and devices, etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 10, storage component 908 may store information and/or software related to the operation and use of device 900. For example, storage component 908 may include a hard disk (e.g., a magnetic disk, an optical disk, a magneto-optic disk, a solid-state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although examples have been described in detail for the purpose of illustration based on what is currently considered to be the most practical and preferred aspects or embodiments, it is to be understood that such detail is solely for that purpose and that the principles described by the present disclosure are not limited to the disclosed aspects or embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A system comprising:
at least one processor programmed or configured to:
determine a subset of account holders from a plurality of account holders based on transaction data for each account holder of the plurality of account holders;
determine a predicted future revenue score for each account holder of the subset of account holders based on a plurality of predictive models; and
generate a segmentation matrix based on the predicted future revenue score and a risk score for each account holder of the subset of account holders.

2. The system of claim 1, wherein the at least one processor is further programmed or configured to:
automatically adjust a credit line value for at least one account holder of the subset of account holders based on the segmentation matrix.

3. The system of claim 1, wherein the at least one processor is further programmed or configured to:
automatically generate an offer for at least one account holder of the subset of account holders based on the segmentation matrix.

4. The system of claim 1, wherein determining the subset of account holders comprises excluding account holders that are not associated with a threshold amount of transaction data.

5. The system of claim 1, wherein determining the subset of account holders comprises excluding account holders that were issued an account within a predetermined time period.

6. The system of claim 1, wherein the plurality of predictive models comprises a predictive interchange revenue model configured to output a component of the predicted future revenue score based at least partially on at least one interchange fee value and a predicted spend amount.

7. The system of claim 1, wherein the plurality of predictive models comprises a first predictive interest model applied to a first group of account holders and a second predictive interest model applied to a second group of account holders to output a component of the predicted future revenue score.

8. The system of claim 1, wherein the plurality of predictive models comprises a foreign transaction fee model configured to output a component of the predicted future revenue score based at least partially on a foreign transaction fee percentage and a predicted cross-border spend amount.

9. A computer-implemented method comprising:
determining, with at least one processor, a subset of account holders from a plurality of account holders based on transaction data for each account holder of the plurality of account holders;
determining, with at least one processor, a predicted future revenue score for each account holder of the subset of account holders based on a plurality of predictive models; and
generating, with at least one processor, a segmentation matrix based on the predicted future revenue score and a risk score for each account holder of the subset of account holders.

10. The computer-implemented method of claim 9, wherein determining the subset of account holders comprises excluding account holders that are not associated with a threshold amount of transaction data.

11. The computer-implemented method of claim 9, wherein determining the subset of account holders comprises excluding account holders that were issued an account within a predetermined time period.

12. The computer-implemented method of claim 9, wherein at least one model of the plurality of predictive models is configured to output the predicted future revenue score based at least partially on at least one interchange fee value.

13. The computer-implemented method of claim 9, further comprising:
automatically adjusting a credit line value for at least one account holder of the subset of account holders based on the segmentation matrix.

14. The computer-implemented method of claim 9, further comprising:
automatically generating an offer for at least one account holder of the subset of account holders based on the segmentation matrix.

15. The computer-implemented method of claim 9, wherein the plurality of predictive models comprises a predictive interchange revenue model configured to output a component of the predicted future revenue score based at least partially on at least one interchange fee value and a predicted spend amount.

16. The computer-implemented method of claim 9, wherein the plurality of predictive models comprises a first predictive interest model applied to a first group of account holders and a second predictive interest model applied to a second group of account holders to output a component of the predicted future revenue score.

17. The computer-implemented method of claim 9, wherein the plurality of predictive models comprises a foreign transaction fee model configured to output a component of the predicted future revenue score based at least partially on a foreign transaction fee percentage and a predicted cross-border spend amount.

18. A computer program product comprising at least one non-transitory computer-readable medium including program instructions that, when executed by at least one processor, cause the at least one processor to:
determine a subset of account holders from a plurality of account holders based on transaction data for each account holder of the plurality of account holders;
determine a predicted future revenue score for each account holder of the subset of account holders based on at least one model; and
generate a segmentation matrix based on the predicted future revenue score and a risk score for each account holder of the subset of account holders.

19. The computer program product of claim 18, wherein the program instructions further cause the at least one processor to:
automatically adjust a credit line value for at least one account holder of the subset of account holders based on the segmentation matrix.

20. The computer program product of claim 18, wherein the program instructions further cause the at least one processor to:
automatically generate an offer for at least one account holder of the subset of account holders based on the segmentation matrix.
